(19) United States
(12) Patent Application Publication
(10) Pub. No.: US 2007/0249253 A1
(43) Pub. Date: Oct. 25, 2007

(54) ELASTIC LAMINATE COMPRISING ELASTIC SUBSTRATE BETWEEN EXTENSIBLE WEBS AND METHOD FOR MAKING

(76) Inventors: Piero Angeli, Sulmona (IT); James W. Cree, Chesterfield, VA (US)

Correspondence Address: HASSE & NESBITT LLC, 8837 CHAPEL SQUARE DRIVE, SUITE C, CINCINNATI, OH, 45249, US

(21) Appl. No.: 11/739,313

(22) Filed: Apr. 24, 2007

Related U.S. Application Data
(60) Provisional application No. 60/745,476, filed on Apr. 24, 2006.

(51) Int. Cl. B32B 27/12

(52) U.S. Cl. 442/394; 442/328; 442/329; 442/333; 156/290; 156/291

(57) ABSTRACT

An elastic laminate comprising an elastic substrate bonded by point bonding to at least one extensible nonwoven web comprising thermoplastic fibers or filaments bonded by point bonding. The bonding points of the extensible nonwoven web are disposed in concentrated areas that are combined with areas having a substantially lower density of bonding points. Also disclosed is a method of making an elastic laminate comprising the steps of forming the nonwoven web, providing an elastic substrate adjacent the nonwoven web, and point bonding the elastic substrate and the nonwoven web to provide the elastic laminate.

### CROSS REFERENCE TO RELATED APPLICATIONS

This application claims the benefit of co-pending U.S. Provisional Application No. 60/745,476, filed Apr. 24, 2006.

### TECHNICAL FIELD

This invention relates to an elastic laminate comprising an elastic substrate bonded by point bonding to at least one extensible nonwoven web, and typically between extensible nonwoven webs. The invention also relates to method for making such an elastic laminate. In one embodiment, the invention relates to a method for producing in a single step the extensible nonwoven web and the laminate by means of point bonding of the layers.

### BACKGROUND OF THE INVENTION

Nonwoven fabrics are used in various industrial and consumer products sectors. In particular, webs of nonwoven fabric are used to produce disposable sheets, disposable garments and hygiene and sanitary products, such as sanitary napkins, incontinence pads and baby diapers.

Nonwoven fabrics can be manufactured using various techniques. The process to form the web of nonwoven fabric entails forming a web of continuous filaments or discontinuous fibers (staple fibers), which are then consolidated according to various techniques to bond the web and obtain the actual nonwoven fabric. The web of fibers can be, for example, a web of carded fibers or a layer of continuous filaments delivered from extrusion heads. The bonding techniques can be of various types, such as mechanical (needle-punching), hydraulic (hydro-entanglement), gluing or thermal bonding.

In the case of thermal bonding or thermal consolidation, the unconsolidated, i.e. unbonded, web is fed through a calendar comprising a smooth cylinder and an engraved cylinder provided with protuberances. The two cylinders are pressed against each other at high pressure, and at least one of the two is heated to cause at least partial localized melting of the thermoplastic fibers.

WO-A-9855295 describes a procedure for producing a composite material composed of two or three textile layers, wherein the fibers forming the textile layers are bonded and the layers are bonded to one another by means of a calendar comprising a pair of engraved rollers. The rollers are produced and controlled for tip-to-tip operation, i.e. with all the protuberances of one roller in phase with the protuberances of the other roller, and form a pattern of bonding spots with a density corresponding to the density of the protuberances on the two rollers.

WO-A-0004215 describes a method for producing a nonwoven fabric by means of thermal consolidation of a web of fibers or filaments, such as a web of textile fibers, made of a thermoplastic material such as polypropylene. Bonding or consolidation is obtained through calendaring with a roller provided with protuberances, which cooperates with a smooth roller.

U.S. Pat. No. 6,395,211 describes a device and a procedure for producing a perforated nonwoven fabric. The web of textile fibers is pre-bonded to form a nonwoven fabric. This is then fed through a calendar with a smooth cylinder coated with a yielding material and a cylinder provided with protuberances. Perforation of the nonwoven fabric is obtained by applying sufficient pressure and heat between the rollers.

U.S. Pat. No. 5,656,119 describes a procedure for producing a multi-layer article with a plastic film interposed between two webs of fibers. The three components are fed to a calendar formed of two engraved cylinders, arranged and phased tip-to-tip, which cause adhesion of the fibers and perforation of the interposed film.

U.S. Pat. No. 5,422,172 describes an elastic laminated sheet of an incrementally stretched nonwoven fibrous web and elastomeric film and a method of making the sheet. The elastic laminates are said to be useful in diapers, surgical gowns, sheets, dressing, hygienic products and the like.

U.S. Pat. No. 6,942,748 describes an elastomeric film bonded between two or more layers of nonwoven webs formed of nonelastomeric thermoplastic fibers. The laminate is said to have in a predefined transverse direction, an elastic elongation value greater than the predefined elastic elongation value of the nonwoven webs, and an ultimate force to break in the predefined transverse direction of at least 3000 g/in.

While the above patents and applications disclose various methods for forming elastic laminates, there is a continuing need for an improved method to produce a laminate having improved softness and transverse directions stretch and recovery.

### SUMMARY OF THE INVENTION

The present invention relates to an elastic laminate comprising an elastic substrate bonded by point bonding to at least one extensible nonwoven web comprising thermoplastic fibers or filaments bonded by point bonding, wherein the bonding points of said extensible nonwoven web are disposed in concentrated areas that are combined with areas having a substantially lower density of bonding points.

The present invention also relates to a method for making an elastic laminate comprising the steps of:
(1) forming an extensible nonwoven web comprising thermoplastic fibers or filaments bonded by point bonding, wherein the bonding points are disposed in concentrated areas that are combined with areas having a substantially lower density of bonding points;
(2) providing an elastic substrate adjacent the nonwoven web; and
(3) point bonding the elastic substrate and the nonwoven web to provide the elastic laminate

### BRIEF DESCRIPTION OF THE DRAWINGS

FIG. 1 is a diagram of a system to make an elastic laminate according to the invention.

FIG. 2 is an enlargement of the nip between the rollers of the first thermal bonding calendar shown in FIG. 1.

FIG. 3 is a schematic plan view of a web delivered from the first thermal bonding calendar.

FIG. 4 is a schematic enlargement of the nip between the rollers of the second embossing or perforating calendar.

FIGS. 5 and 6 are enlarged schematic cross sections of the product delivered from the second calendar in the case of embossing and perforation, respectively.

FIG. 7 is an enlarged cross section of an elastic laminate of the invention.

### DETAILED DESCRIPTION OF THE INVENTION

As used herein, the term “machine direction” means the direction in which precursor webs are formed, which is the longitudinal direction of an uncut web.

As used herein, the term “transverse direction” means the cross direction, disposed at 90° to the machine direction, and extends across the width of the initially formed precursor web.

As used herein, the term “relaxed state” means the only tension applied to the material is a low winding tension exhibited by the winder to prevent the web from getting stuck in the bonding nip.

The nonwoven web herein is an essentially unbonded web of thermoplastic fibers or filaments bonded by bonding points distributed according to concentrated areas. The areas of concentrated bonding points are typically combined with areas devoid, either partially or totally, of bonding points.

In one embodiment, to produce the bonding points distributed in concentrated areas, the web of unbonded fibers or filaments is fed between two counter-rotating rollers provided with protuberances. During rotation in the nip between the two rollers, part of the protuberances of a first roller are carried opposite corresponding protuberances of a second roller, while part of the protuberances of the first roller are disposed opposite depressions between the protuberances of the second roller. The bonding points are formed between pairs of protuberances opposite each other and at least partially coinciding. This allows bonded areas to be obtained in which the bonding points of the fibers are concentrated, surrounded by areas devoid (partially or totally) of bonding points. The distance between the bonding areas is in any case suitable to provide sufficient bonding of the fibers or filaments.

Typically, the bonding points in the concentrated areas have a density ranging from about 5 to about 200 points/cm², typically from about 30 to about 100 points/cm², and even more typically from about 30 to about 70 points/cm², while the distance between bonding areas is typically from about 5 to about 30 mm, more typically about 8 to about 20 mm. In any case the design provides, as a function of the density and of the length of the fibers, adequate bonding, i.e. adequate cohesion between fibers of the web, while reducing the bonding points to a minimum to obtain a particularly soft and thick web.

The fibers or filaments typically are helically or zig-zag crimped and typically have a count ranging from about 1 to about 15 dtex. The fibers or filaments can be comprised of polyethylene, polypropylene, polyester or biodegradable polylactic acid (PLA) fibers. The fibers or filaments can be bicomponent, i.e. with a core and sheath formed of different polymers. For example, the following combinations can be used: polypropylene-polyethylene; polyester-polyethylene; polyester-copolyester; PLA-coPLA. Viscose or cotton can also be used as materials for the fibers or filaments. In general, the fibers or filaments can be produced with materials known and typically used to produce nonwoven fabrics consolidated using heat.

The nonwoven web can be a web of continuous filaments or of discontinuous fibers, or a combination of filaments and fibers. In one embodiment, the web is formed of discontinuous carded fibers.

The nonwoven web can be used as a component of a final article, such as a sanitary napkin, a baby diaper or the like. However, the web bonded in this way can also be subjected to further processes, such as a supplementary bonding process, an embossing process, a perforation process, or a combination of these. Furthermore, the bonded web of fibers or filaments as described can be joined to a elastic film or to another component to form a composite semi-finished material. This semi-finished product can be embossed or perforated, subjected to both embossing and perforation, or subject to other processes.

According to another aspect, the invention relates to a web of thermoplastic textile fibers or filaments bonded by point bonding, characterized in that said bonding points are disposed in concentrated areas, said areas of concentrated bonding points combined with areas with more or less dense bonding points.

FIG. 1 schematically shows a possible configuration of a line for producing a nonwoven fabric according to the invention. A carding machine is indicated with 1, which produces a textile web V of carded and unbonded fibers. The web V can also be formed by superimposing more than one web produced by more than one carding machine. Typically, the web V is composed of fibers, which may be bi-component, with a core composed of a first thermoplastic material and a sheath composed of a second thermoplastic material, where the second thermoplastic material has a lower softening temperature than the material forming the core of the fiber. Such bi-component fibers and the materials with which they can be produced are known to those skilled in the art and not described herein.

The fibers can typically have a length of from about 10 to about 100 mm, typically about 20 to about 80 mm, and even more typically about 25 to about 50 mm, with a count ranging, for example, from about 1 dtex to about 15 dtex. The weight of the web V ranges, for example, from about 5 g/m² to about 150 g/m², typically from about 10 to about 35 g/m², and even more typically from about 15 to about 30 g/m².

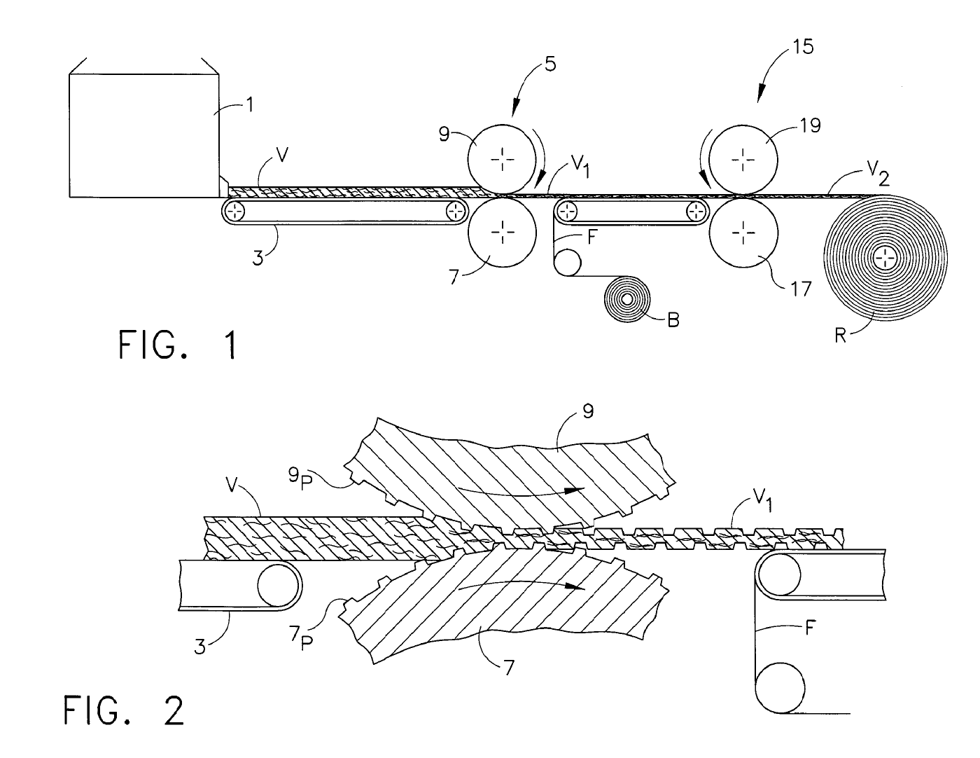

By means of a belt conveyor 3, the web V of carded and unconsolidated textile fibers is fed to a first calendar 5, comprising a bottom roller 7 and a top roller 9, made of steel or another sufficiently hard material. Characteristically, the two rollers 7 and 9, counter-rotating as indicated by the arrows in the drawing, are provided with respective protuberances 7P and 9P, as shown schematically in the enlargement in FIG. 2. The protuberances can be obtained by mechanical engraving, chemical etching, laser engraving, or other suitable ways. Typically, they will have a truncated cone or truncated pyramid shape, although other configurations of the protuberances are also possible.

The protuberances 7P and 9P are typically disposed with a density of from about 5 to about 200 protuberances/cm², more typically in the order of about 30 to about 100 protuberances/cm², and even more typically from about 30 to about 70 protuberances/cm². The height of the protuberances can be from about 0.1 to about 5 mm. The dimension of the front surface of the protuberances and the density with which they are distributed are such that the front surface of the protuberances of each of the two rollers occupies a percentage ranging from about 5 to about 40%, typically from about 15 to about 30%, of the total cylindrical surface enveloping the respective roller.

In the nip between the rollers 7 and 9, the protuberances are typically disposed in such as way that only some protuberances of the roller 7 are opposite to and aligned with the protuberances of the roller 9, i.e. in a tip-to-tip arrangement. The other protuberances are out of phase with one another. This effect can be obtained in various ways. For example, the engraving of the rollers can essentially be the same but the peripheral speeds of the rollers may differ slightly from each other. Alternatively, the pitch of the protuberances on one roller may not be identical to the pitch of the protuberances on the opposed roller. In another embodiment, the protuberances may be disposed aligned according to helical alignments chosen so as to obtain partial correspondence between the tips of one roller and the tips of the other. These different methods may also be combined to obtain non-correspondence of all the tips of the two rollers along the nip of the calendar. Moreover, the diameters of the two rollers may be slightly different, also so that with each revolution of the rollers, the protuberances disposed in a tip-to-tip arrangement change to distribute wear of the protuberances evenly throughout the entire surface of the rollers 7 and 9.

The distribution, dimension and density of the protuberances 7P, 9P, and reciprocal difference in phase therebetween, are chosen so that the average bonded surface of the web typically ranges from about 1% to about 15%, more typically from about 3 to about 10%, e.g., from about 4% to about 8%, of the total surface of the web.

The distance between centers of the rollers 7 and 9 may be chosen so that the front surfaces of the protuberances in the tip-to-tip arrangement only press against each other with modest pressure. For example, the force per unit of length, i.e. the linear pressure, in the nip between the two rollers (without the web interposed) may be equal to or less than 30 N/mm, versus the conventional 75 N/mm. According to one embodiment, the distance between centers of the rollers is chosen so that, in the absence of a web of fibers, there is no contact between these rollers, but rather the protuberances in tip-to-tip arrangement are spaced apart, for example, by an amount above 0 mm but below about 1 mm, typically from about 0.02 to about 0.8 mm, and even more typically from about 0.05 and to about 0.5 mm.

When the web V of unbonded fibers is fed into the nip between the rollers 7 and 9, the web is compressed and its thickness is essentially calibrated by the rollers of the calendar. As one or the other, or typically both, of the rollers is heated to a temperature close to the softening or melting temperature of the fibers. When the fibers are bicomponent, melting of the sheath of the fibers is obtained. This melting takes place in the areas in which the protuberances 7P and 9P are in the tip-to-tip arrangement. In areas in which said reciprocal correspondence between protuberances is absent, bonding takes place through the action of heat. In the areas with tip-to-tip correspondence, the web is compressed sufficiently to obtain compression and bonding, even when the front surfaces of opposite protuberances might not touch. The reduction in linear pressure (e.g., from the conventional about 75 N/mm to about 30 N/mm) means that both rollers can be perfectly cylindrical and without systems to take up the flexure, thereby simplifying said systems.

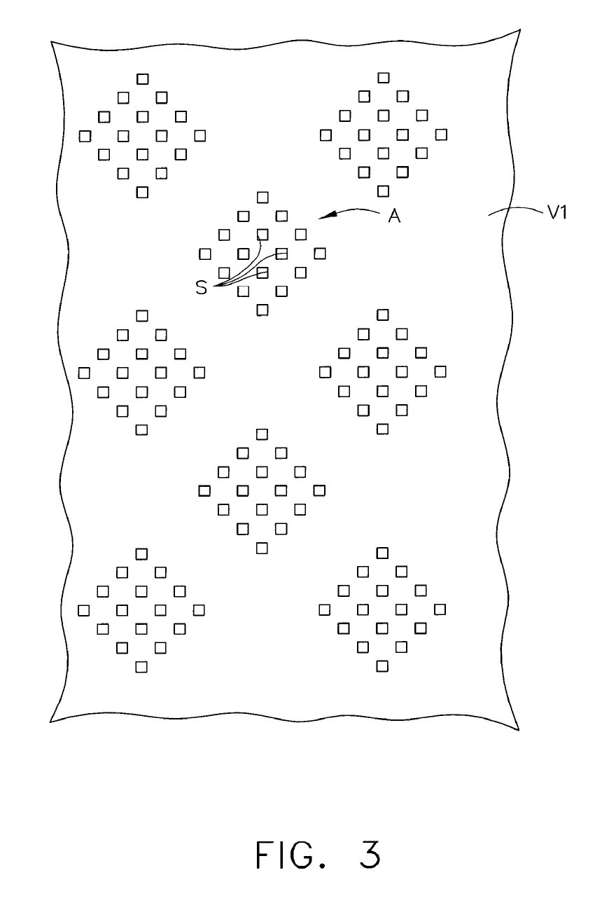

Due to imprecise correspondence between protuberances 7P and 9P, the bonding points produced on the web V1 delivered from the calendar 5 are distributed in a discontinuous and varying manner. FIG. 3 schematically shows one possible distribution of these bonding points S. The design and distribution of binding points can vary due, for example, to more or less marked slipping between the rollers, which can even be of a non-negligible extent, especially when the rollers 7 and 9 are not in reciprocal contact. The bonding points S are typically distributed according to discrete zones or areas A, which areas are spaced apart to an extent essentially greater than the pitch between the protuberances on one or the other of the two rollers, but sufficiently close to provide adequate overall bonding of the fibers of the web V.

The product delivered from the calendar 5 is a bonded or partially bonded, i.e. consolidated or partially consolidated, web that differs from thermally bonded webs of the conventional type. The latter are typically bonded according to a very dense and even distribution of points throughout the entire extension of the web, with a pitch of bonding points corresponding to the pitch of the protuberances on the engraved roller of the calendar. On the other hand, the product obtained with the method herein is characterized by discontinuity in the distribution of bonding points and therefore uneven distribution of said points, with large surface zones (surrounding the areas A) in which the fibers are at least partially devoid of bonding by pressure.

The nonwoven web thus obtained is typically softer and more voluminous than a web bonded by conventional thermal bonding. However, even when the fibers are staple fibers, they are sufficiently bonded, or consolidated, since the areas A in which the bonding points are concentrated are spaced apart from each other by a distance generally below the average length of the fibers. For example, if the fibers have a length of 40 mm, the areas A can be spaced apart from one another by an extent of, for example, between 5 and 20 mm. Consequently, each fiber is statistically affected by at least two bonding points S, or in general by several bonding points S, thereby providing adequate bonding or consolidation of the fibers.

The web V typically has a high initial thickness (e.g., about 10 to about 20 mm) when fed into the calendar 5. When delivered therefrom, the web has a calibrated thickness. This thickness is often from about 0.20 to about 1.00 mm, and typically from about 0.25 to about 0.50 mm. With the same basis weight, i.e. weight per surface unit, the consolidated web delivered from the calendar 5 is essentially thicker than the web obtained with conventional point bonding. The increase in thickness with the same basis weight typically is from about 20 to about 80%, according to the basis weight and the operating conditions of the calendar. The basis weight of the bonded web V1 typically ranges from about 10 to about 40 g/m², more typically from about 12 to about 35 g/m², e.g., from about 15 to about 30 g/m².

In calendars conventionally used for thermal bonding, it is often necessary for the web being fed to be subjected to a certain degree of pull. This pull is obtained by imparting a peripheral speed to the rollers of the calendar of from about 10% to about 30% greater than the speed with which the conveyor belt feeds the unbonded web V. Pull is necessary to counterbalance the aerodynamic effect of the air which from the nip of the calendar is pushed backwards towards the area from which the web is fed. This reverse motion of the air is due to the fact that the volume of the web fed to the calendar is reduced. The air present inside the unbonded web is expelled as a consequence of compression of the web by the calendar, and tends to be blown backwards.

Since the web V fed to the calendar is unbonded and therefore has essentially no mechanical resistance, the air current which is produced causes disturbance in the feed of the web and disarranges the fibers. The peripheral speed of the rollers being greater than the advance speed of the web fed compensates for this effect. Nonetheless, the pull has a negative effect on the final quality of the consolidated web. This negative effect takes the form of unevenness in the density of the fibers in the consolidated web, with the onset of areas with a density below the desired density, i.e. with reduced coverage. This phenomenon is the result of the stress to which the web is subjected as a consequence of pull.

It has now been found that by using two rollers both provided with protuberances and additionally disposed so that the protuberances of one roller do not correspond entirely with the protuberances of the other roller in the lamination nip, the pull that must be imposed on the web being fed (i.e. the difference between peripheral speed of the rollers and feed speed of the web) is essentially lower than the pull required in conventional calendars and can even be entirely eliminated.

Notwithstanding the absence of pull or the presence of very limited pull (below about 10%, and typically below about 5%) at particularly high production speeds, a product is obtained which is not affected by the aerodynamic effects described above. On the other hand, the absence of pull or the use of a very low percentage of pull improves the quality of the product in terms of evenness of the fiber density, without the formation of areas with low coverage, i.e. with a density of fibers much lower than the density of the surrounding areas. This beneficial effect seems to be due to the fact that the presence of protuberances on both rollers increases the empty space in the nip between the rollers 7 and 9 of the calendar 5 with respect to conventional calendars. This increases the possibility for air to be ejected from the opposite side of the nip with respect to the side from which the web is fed, thereby reducing the amount of air blown backwards towards the unconsolidated web. The lack of complete correspondence between opposite protuberances 7P and 9P makes this effect even more significant.

Besides the aforesaid advantages, the thermal bonding procedure using a pair of rollers provided with protuberances partially out of phase allows a reduction in linear pressure between the rollers, i.e. the force per unit of axial length of the rollers. Considering that only about 20 to about 30% of the protuberances of the rollers are in reciprocal contact or in tip-to-tip opposition, as the pressure on the web in the bonding point must in any case always be equal to the pressure normally used to obtain bonding also in conventional devices, the linear pressure and therefore the overall flexural stress are essentially lower (e.g., about 20 to about 30% of those found in conventional systems). This reduces or eliminates the problem represented by flexural deformation of the rollers, and consequently the need to produce convex rollers to guarantee bonding along the entire width of the web. This results in a considerable saving in costs and reduction of complications during the production of the rollers.

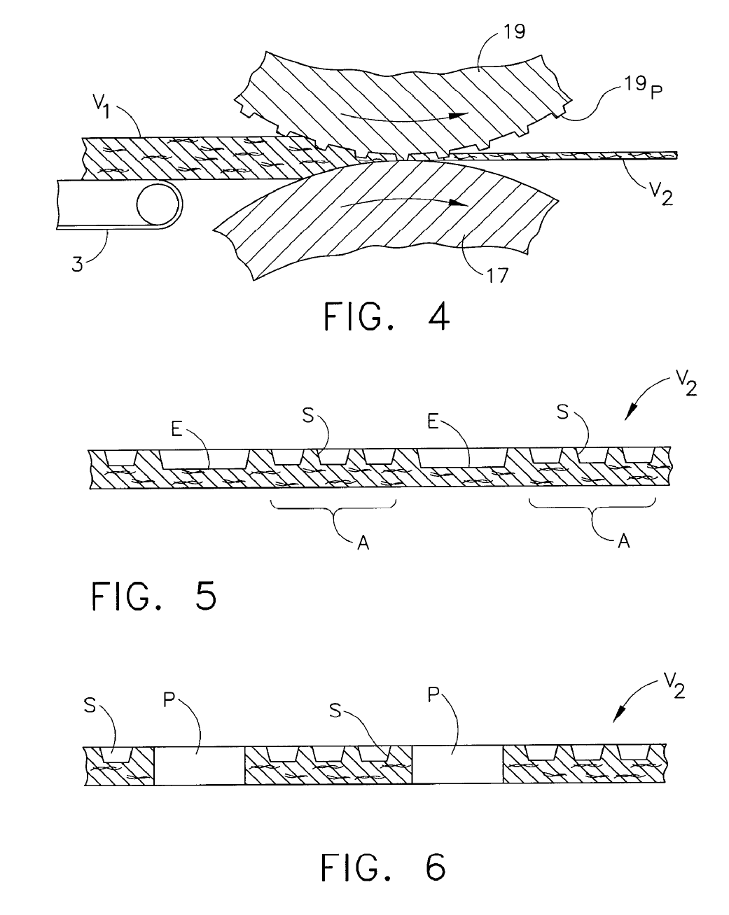

The consolidated web V1 delivered from the calendar 5 can be used as is, for example to produce topsheets for sanitary napkins or diapers, or as an intermediate layer for the acquisition and/or distribution of body fluids below a topsheet which can, for example, be made of a perforated plastic material. The web V1 consolidated by the calendar 5 can also be subjected to further processing. As shown in FIG. 1, the web V1 may be fed to a second calendar 15 composed of a counter-rotating bottom roller 17 and top roller 19, which for example, may be made of steel. In one embodiment, the roller 17 has a smooth surface, i.e. without protuberances, while the roller 19 is provided with protuberances 19P, such as shown in FIG. 4. According to another embodiment, the distance between the centers of the two rollers 17, 19 of the second calendar 15 is such that the protuberances 19P press against the smooth surface of the roller 17 (see the schematic enlargement in FIG. 4 of the nip of the second calendar). The pressure between the two rollers can be greater than the pressure between the rollers 7 and 9. Typically, the linear pressure in this case is between about 50 N/mm and about 200 N/mm. One or the other, or both, of rollers 17, 19 can be heated to a temperature in proximity to, and typically greater than, the softening temperature of the fibers forming the web V1.

In one embodiment, the peripheral speed of the two rollers is the same. The web V1, already consolidated in the first calendar 5, is thus subjected to embossing with compression by the protuberances 19P. One result is illustrated in FIG. 5, where E indicates the depressions produced by the protuberances 19P. These are located on one side of the web V2 delivered from the second calendar 15. The opposite side of the web is in contact with the smooth surface of the roller 17 and therefore remains essentially smooth. FIG. 5 schematically indicates the areas A of concentration of the bonding points. The embossed web V2 obtained is considerably softer and thicker than webs obtained with conventional technologies.

According to another embodiment of the invention, the web V1 bonded in the first calendar 5 is perforated in the calendar 15. This can be obtained, for example, with a combined effect of pressure, temperature and reciprocal slipping between the rollers 17, 19, in a manner known to those skilled in the art. FIG. 6 schematically shows a section of a web V2 thermally bonded in points (S) and perforated (P). In this case, the thickness and softness obtained on the perforated web V2 are greater than that of webs obtained with conventional thermal bonding systems.

The elastic laminate herein comprises an elastic substrate bonded by point bonding to at least one extensible nonwoven web as described above but typically between at least two layers of the above described extensible nonwoven webs. The elastic laminate may be formed simultaneously with the nonwoven web or webs, or the laminate may be formed after the nonwoven web or webs are formed. In either case, the bonding points of the extensible nonwoven web or webs are disposed in concentrated areas that are combined with areas having a substantially lower density of bonding points.

In the embodiment shown in FIG. 1, an elastic substrate, such as elastic film F, is fed from a reel B and joined between two nonwoven webs V1 (only the top web V1 is shown in FIG. 1). The elastic substrate and the nonwoven webs V1 simultaneously enter the thermal bonding nip between rollers 17 and 19 with no tension applied to the webs or the elastic substrate, which are all in a relaxed state. The protuberances of the upper cylinder and the smooth lower cylinder of the bonding nip create new thermally fused bond sites that permanently attach the elastic substrate between the two webs V1. The bonding points are typically individual bond sites that are distributed uniformly across the entire laminate, although the bonding points may be distributed randomly, non-uniformly, or in various patterns. The three layers exit the nip as a single layer with the elastic substrate encapsulated permanently between the two webs V1. The newly formed laminate is then slit and wound on a roll for storage or shipment to customers.

In another embodiment, the nonwoven webs and the laminate are simultaneously formed by passing two layers of the textile web V, with an elastic substrate such as elastic film F therebetween, through a thermal bonding nip such as between rollers 7 and 9, with no tension applied to the webs or the elastic substrate, which are all in a relaxed state. The protuberances of the upper cylinder and lower cylinder of the bonding nip create new thermally fused bond sites that permanently attach the elastic substrate between two extensible nonwoven webs, such as webs V1. The three layers exit the nip as a single layer with the elastic substrate encapsulated permanently between the two webs. The newly formed laminate is then slit and wound on a roll for storage or shipment to customers.

The elastic substrate typically is of the polyolefin type that is processable into a film or into a nonwoven web with filaments that are extruded by known direct fiber extrusion processes, such as spunbond or meltblown processes, for direct lamination by melt extrusion onto the fibrous web in one embodiment. Suitable elastomeric polymers may also be biodegradable or environmentally degradable. Suitable elastomeric polymers for the film or nonwoven include poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinylacetate), poly(ethylene-methylacrylate), poly(ethylene-acrylic acid), poly(ethylene butylacrylate), polyurethane, poly(ethylene-propylene-diene), ethylene-propylene rubber. A new class of rubber-like polymers may also be employed and they are generally referred to herein as polyolefins produced from single-cite catalysts. The most preferred catalysts are known in the art as metallocene catalysts whereby ethylene, propylene, styrene and other olefins may be polymerized with butene, hexene, octene, etc., to provide elastomers suitable for use in accordance with the principles of this invention, such as poly(ethylene-butene), poly(ethylene-hexene), poly(ethylene-octene), poly(ethylene-propylene) and/or polyolefin terpolymers thereof. The elastomeric film typically has a gauge or thickness between about 0.25 and about 10 mils. In disposable applications, the film thickness typically is from about 0.25 to about 2 mils.

The laminate of the invention can be incrementally stretched in the cross direction (CD) to form a CD stretchable and recoverable composite. Furthermore, CD stretching may be followed by stretching in the machine direction (MD) to form a composite which is stretchable and recoverable in both CD and MD directions. As indicated above, the laminate may be used in many different applications such as baby diapers, baby training pants, catamenial pads and garments, and the like where stretchable and recoverable properties, as well as fluid barrier properties are needed

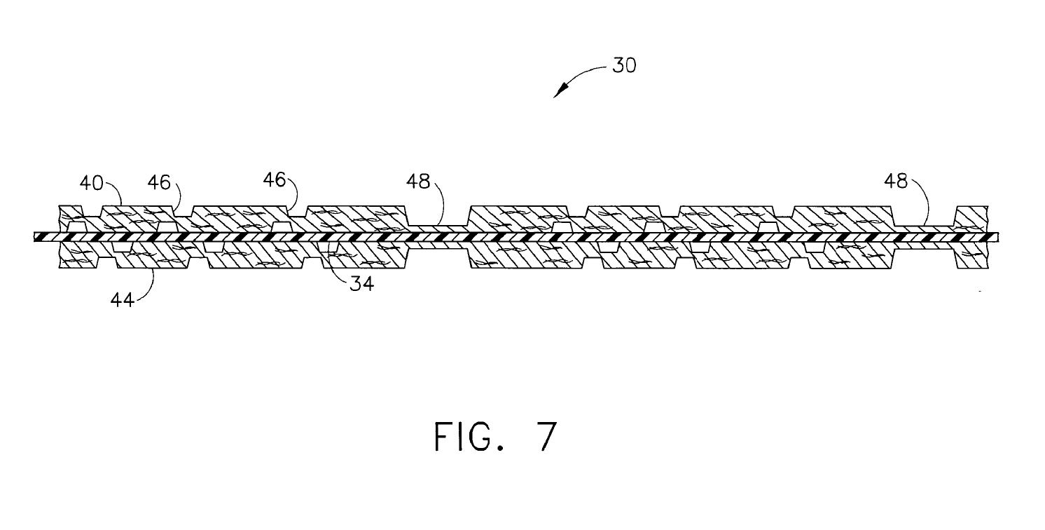

A tear resistant, air-pervious, laminate 30 according to one embodiment of the invention is shown in FIG. 7. The laminate 30 is suitable for use in sanitary products that require a closure system provided by the laminate that is soft to the touch and can stretch in a transverse direction. The three-layer laminate 30 illustrated in FIG. 7 has a center ply that is formed of an elastic polymeric film 34 having a top surface and a bottom surface. A top layer comprises a first nonwoven web 40 having a bottom surface that is bonded to the top surface of the elastomeric film 34. The bottom ply of the laminate 30 comprises a second nonwoven web 44 having a top surface that is bonded to the bottom surface of the elastomeric film 34.

In one embodiment the elastic polymeric film 34 may be formed of either a metallocene based low density polyethylene (m-LDPE), or a block-copolymer blend that contains styrene/butadiene/styrene (SBS), styrene/ethylene-butylene/styrene (SEBS), ethylene vinyl acetate (EVA), thermoplastic urethane, or cross-linked rubber. Typically, the elastic polymeric film has a basis weight of from about 18 g/m² to about 100 g/m². In one embodiment, an m-LDPE film has a basis weight of about 25 g/m², whereas block copolymer films have a basis weight of about 50 g/m². Also, it is desirable that the elastic polymeric films have less than 25% set when stretched 50%.

In addition to having good elasticity, it is also desirable that the elastic polymeric film 34 be puncture resistant. For example, if the laminate 30 embodying the present invention is used to form pull tabs, or ears, for diaper products, it is important that the laminate not be easily punctured by long fingernails. Since nonwoven materials generally provide little or no puncture resistance, the elastic polymeric film 34 should have a puncture resistance, as represented by a Dart Impact value, of at least 400 g.

The first and second nonwoven webs 40 and 44 are extensible webs formed as described above. After forming, the first and second nonwoven webs are thermally point bonded to the elastomeric film 34. More specifically, as shown in FIG. 7, the bottom surface of the first nonwoven web 40 is bonded to the top surface of the film 34, and the top surface of the second nonwoven web 44 is bonded to the bottom surface of the film 34. The point bonding may comprise nonwoven only bonds, such as at points 46, and nonwoven to film bonds, such as at points 48. Typically, the bonding between the respective webs 40, 44 and film 34 is carried out simultaneously by point bonding as described above. For this purpose, it is desirable that at least about 10% of the randomly disposed fibers in the first and second webs have approximately equal softening temperatures. The nonwoven webs are thus welded, typically by a combination of thermal and mechanical energy, to provide a peel force greater than 155 N/m (400 g/in.) of width pattern as illustrated in FIG. 3.

While particular embodiments of the present invention have been illustrated and described, various other changes and modifications can be made without departing from the spirit and scope of the invention. It is therefore intended to cover all such changes and modifications that are within the scope of this invention.

What is claimed is:

1. An elastic laminate comprising an elastic substrate bonded by point bonding to at least one extensible nonwoven web comprising thermoplastic fibers or filaments bonded by point bonding, wherein the bonding points of said extensible nonwoven web are disposed in concentrated areas that are combined with areas having a substantially lower density of bonding points.

2. An elastic laminate according to claim 1 wherein the nonwoven web comprises areas of concentrated bonding points surrounded by areas essentially devoid of bonding points.

3. An elastic laminate according to claim 1 wherein the nonwoven web is formed of discontinuous carded fibers.

4. An elastic laminate according to claim 3 wherein in the nonwoven web, the distance between the areas in which the bonding points are concentrated is below the average length of said fibers.

5. An elastic laminate according to claim 1 wherein the elastic substrate is a polyolefin film.

6. An elastic laminate according to claim 1 wherein in the nonwoven web, the bonding points in the areas in which the bonding points are concentrated have a density ranging from about 30 to about 100 points/cm².

7. An elastic laminate according to claim 1 wherein in the nonwoven web, the areas provided with said concentrated bonding points are separated from one another by a distance ranging from about 5 to about 30 mm.

8. An elastic laminate according to claim 1 wherein the nonwoven web comprises fibers having an average length of from about 20 to about 80 mm.

9. An elastic laminate according to claim 1 wherein the nonwoven web has a basis weight ranging from about 10 to about 40 g/m².

10. An elastic laminate according to claim 1 wherein in the nonwoven web, the bonded area ranges from about 1% to about 15% of the overall surface of the web.

11. An elastic laminate according to claim 1 wherein the nonwoven web is formed of discontinuous carded fibers having an average length of from about 20 to about 80 mm, the elastic substrate is a polyolefin film, and the bonding points in the areas in which the bonding points are concentrated have a density ranging from about 30 to about 100 points/cm².

12. An elastic laminate comprising an elastic substrate bonded by point bonding between extensible nonwoven webs comprising thermoplastic fibers or filaments bonded by point bonding, wherein the bonding points of said extensible nonwoven webs are disposed in concentrated areas that are combined with areas having a substantially lower density of bonding points.

13. An elastic laminate according to claim 12 wherein the nonwoven webs are formed of discontinuous carded fibers having an average length of from about 20 to about 80 mm, the elastic substrate is a polyolefin film, and the bonding points in the areas in which the bonding points are concentrated have a density ranging from about 30 to about 100 points/cm².

14. A method for making an elastic laminate comprising the steps of:
1) forming an extensible nonwoven web comprising thermoplastic fibers or filaments bonded by point bonding, wherein the bonding points are disposed in concentrated areas that are combined with areas having a substantially lower density of bonding points;
2) providing an elastic substrate adjacent the nonwoven web; and
3) point bonding the elastic substrate and the nonwoven web to provide the elastic laminate.

15. A method according to claim 14 wherein the nonwoven web is formed by feeding a web of unbonded fibers or filaments between two counter-rotating rollers provided with protuberances; and wherein during rotation in the nip between said two rollers part of the protuberances of a first roller are carried at least partially opposite corresponding protuberances of a second roller, while part of the protuberances of said first roller are disposed corresponding depressions between the protuberances of the second roller, the bonding points being formed between pairs of protuberances opposing each other.

16. A method according to claim 14 wherein the nonwoven web comprises areas of concentrated bonding points combined with areas completely devoid of bonding points.

17. A method according to claim 14 wherein the nonwoven web comprises discontinuous carded fibers.

18. A method according to claim 14 wherein the nonwoven web bonded by means of said point bonding is subsequently embossed in a calendar comprising a roller equipped with protuberances cooperating with a smooth roller, at least one of said two rollers being heated and said two rollers being pressed against each other.

19. A method according to claim 14 wherein the nonwoven web bonded by point bonding is subsequently perforated in a calendar comprising a roller provided with protuberances cooperating with a smooth roller, at least one of said two rollers being heated and said two rollers being pressed against each other.

20. A method according to claim 14 wherein the elastic substrate is a polyolefin film.

21. A method according to claim 15 wherein the two rollers are pressed against each other with a force per unit of length equal to or less than about 30N/mm.

22. A method according to claim 21 wherein the distance between the centers of the two rollers is such that the distance between opposite protuberances of the two rollers in the nip therebetween is below about 1 mm.

23. A method according to claim 14 wherein the elastic laminate is formed simultaneously with the nonwoven web.

24. A method according to claim 23 wherein the nonwoven web is formed of discontinuous carded fibers having an average length of from about 20 to about 80 mm, the elastic substrate is a polyolefin film, and the bonding points in the areas in which the bonding points are concentrated have a density ranging from about 30 to about 100 points/cm².

25. A method according to claim 14 wherein the elastic substrate is provided between at least two layers of the nonwoven web, and the elastic substrate and the layers of nonwoven web are point bonded to provide the elastic laminate.
